(19) United States
(12) Patent Application Publication
(10) Pub. No.: US 2016/0291363 A1
(43) Pub. Date: Oct. 6, 2016

(54) LIQUID CRYSTAL DISPLAY

(71) Applicant: Samsung Display Co., Ltd., Yongin-si (KR)

(72) Inventors: Hyoung Sub LEE, Yongin-si (KR); Sung Hee HONG, Hwaseong-si (KR)

(21) Appl. No.: 14/858,822

(22) Filed: Sep. 18, 2015

(30) Foreign Application Priority Data
Apr. 3, 2015 (KR) 10-2015-0047705

(51) Int. Cl. G02F 1/1341; G02F 1/1339; G02F 1/1333; G02F 1/1368; G02F 1/1337

(52) U.S. Cl. CPC G02F 1/1341; G02F 1/1368; G02F 1/1337; G02F 1/133377; G02F 1/13394; G02F 1/133345

(57) ABSTRACT

Provided is a liquid crystal display including: a substrate including a first portion, a second portion receiving more stress than the first portion, and a plurality of pixel areas disposed in a matrix form; a plurality of thin film transistors and pixel electrodes formed on the substrate; a roof layer disposed on the pixel electrodes such that a plurality of microcavities are formed; injection holes positioned at two edges of the microcavities; a first support member disposed adjacent to an injection hole in the first portion; a second support member disposed adjacent to an injection hole in the second portion; an alignment layer positioned on an inner surface of each of the microcavities; and a liquid crystal layer positioned in each of the microcavities, in which a size of a cross-sectional area of the second support member is greater than that of the first support member.

### CROSS-REFERENCE TO RELATED APPLICATION

This application claims priority to and the benefit of Korean Patent Application No. 10-2015-0047705 filed in the Korean Intellectual Property Office on Apr. 3, 2015, the entire contents of which are incorporated herein by reference.

### BACKGROUND

(a) Technical Field

The present disclosure relates to a liquid crystal display.

(b) Description of the Related Art

A liquid crystal display, which is one of the most common types of flat panel displays currently in use, includes two sheets of display panels with field generating electrodes, such as a pixel electrode, a common electrode, and the like, and a liquid crystal layer interposed therebetween.

To display an image, the liquid crystal display generates an electric field in the liquid crystal layer by applying voltage to the field generating electrodes. The generated electric field determines the direction of the liquid crystal molecules of the liquid crystal layer and thereby determines the polarization of incident light by the liquid crystal layer. Thus, by controlling the strength of the generated electric field, the liquid crystal display can control the polarization of incident light to display images.

The two display panels configuring the liquid crystal display may include a thin film transistor array panel and an opposing display panel. In the thin film transistor array panel, a gate line transferring a gate signal and a data line transferring a data signal are formed to cross each other, and a thin film transistor connected with the gate line and the data line, a pixel electrode connected with the thin film transistor, and the like may be formed. In the opposing display panel, a light blocking member, a color filter, a common electrode, and the like may be formed. Further, in some cases, the light blocking member, the color filter, and the common electrode may be formed on the thin film transistor array panel.

In a traditional liquid crystal display, two sheets of substrates for the thin film transistor array panel and the opposing display panel are used, and a process of forming and bonding the aforementioned constituent elements onto each substrate is required. As a result, the liquid crystal display is heavy and thick, and has a higher cost, a longer processing time, and the like. Recently, a technique of manufacturing a display device by forming a tunnel-shaped structure on one substrate and injecting a liquid crystal into the structure has been developed.

The above information disclosed in this Background section is only for enhancement of understanding of the background of the disclosure and therefore may contain information that does not form the prior art that is already known in this country to a person of ordinary skill in the art.

### SUMMARY

The present disclosure provides a liquid crystal display using one substrate, which has the advantages of preventing a structural deformation due to stress.

An exemplary embodiment of the present disclosure provides a liquid crystal display including: a substrate including a first portion, a second portion receiving more stress than the first portion, and a plurality of pixel areas disposed in a matrix form spanning the first and second portions; a plurality of thin film transistors formed on the substrate; a plurality of pixel electrodes, each connected to a thin film transistor and disposed in a pixel area; a roof layer disposed on the pixel electrodes to be spaced apart from the pixel electrodes such that a plurality of microcavities is formed between the pixel electrodes and the roof layer; injection holes positioned at two edges of each of the microcavities; a first support member disposed adjacent to an injection hole positioned at one edge of a microcavity in the first portion and supporting the roof layer; a second support member disposed adjacent to an injection hole positioned at one edge of a microcavity in the second portion and supporting the roof layer; an alignment layer positioned on an inner surface of each of the microcavities; and a liquid crystal layer positioned in each of the microcavities, in which a size of a cross-sectional area of the second support member is greater than a size of a cross-sectional area of the first support member.

The second portion may be positioned at ¼ of a length and ¾ of a length of the substrate.

The first support members may be disposed at two edges of the microcavity in the first portion, the two edges thereof are adjacent to each other in a column direction and face each other, and the second support members may be disposed at two edges of the microcavity in the second portion, the two edges thereof are adjacent to each other in the column direction and face each other.

The microcavities may be disposed in a matrix form, and a first valley may be formed between the microcavities positioned in different rows.

The first support member and the second support member may be disposed to be adjacent to two sides of the first valley.

Each of the first support member and the second support member may be positioned to be adjacent to only one first valley of a group consisting of an odd numbered first valley and an even numbered first valley.

The liquid crystal display may further include step members formed between the first support member and the second support member and the roof layer, wherein the step members have a width greater than that of each of the first support member and the second support member.

The first support member, the second support member, the roof layer, and the step member may be made of the same material.

A plurality of first support members is disposed at one edge of the microcavity in the first portion, and a plurality of second support members may be disposed at one edge of the microcavity in the second portion.

The number of second support members disposed at one edge of the microcavity in the first portion may be greater than the number of first support members disposed at one edge of the microcavity in the second portion.

The liquid crystal display may further include a capping layer covering the injection holes and disposed on the roof layer.

The liquid crystal display may further include a common electrode disposed on an upper inner surface of each of the microcavities, in which the common electrode may be disposed between the alignment layer and the roof layer.

The liquid crystal display may further include an insulating layer disposed between each of the first support member and the second support member and a corresponding pixel electrode, in which each of the first support member and the second support member may overlap with the corresponding pixel electrode.

According to an exemplary embodiment of the present disclosure, a cross-sectional area of a support member disposed at a portion that receives relatively more stress is greater than a cross-sectional area of a support member disposed at a portion that receives relatively less stress. As a result, it is possible to prevent a roof layer around an injection hole from being deformed due to stress.

Further, the number of support members disposed at a portion that receives relatively more stress is greater than the number of support members disposed at a portion that receives relatively less stress, and as a result, it is possible to prevent a roof layer around an injection hole from being deformed due to stress.

### BRIEF DESCRIPTION OF THE DRAWINGS

FIG. 1 is a diagram schematically illustrating a liquid crystal display according to an exemplary embodiment of the present disclosure.

FIGS. 2 and 3 are plan views schematically illustrating the liquid crystal display according to an exemplary embodiment of the present disclosure.

FIG. 4 is a layout view of one pixel of part A of the liquid crystal display according to an exemplary embodiment of the present disclosure.

FIG. 5 is a cross-sectional view illustrating one example of a cross section taken along line V-V of FIG. 2.

FIG. 6 is a cross-sectional view illustrating one example of a cross section taken along line VI-VI of FIG. 2.

FIG. 7 is a layout view of one pixel of part B of the liquid crystal display according to an exemplary embodiment of the present disclosure.

FIG. 8 is a cross-sectional view illustrating one example of a cross section taken along line VIII-VIII of FIG. 2.

FIGS. 9 and 10 are layout views schematically illustrating a liquid crystal display according to another exemplary embodiment of the present disclosure.

### DETAILED DESCRIPTION OF THE EMBODIMENTS

The present system and method are described more fully hereinafter with reference to the accompanying drawings in which exemplary embodiments of the present system and method are shown. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification.

In addition, the size and thickness of each configuration shown in the drawings are arbitrarily shown for understanding and ease of description, but the present disclosure is not limited thereto.

In the drawings, the thickness of layers, films, panels, regions, etc., are exaggerated for clarity. It will be understood that when an element, such as a layer, film, region, or substrate, is referred to as being “on” another element, it may be directly on the other element, or intervening elements may also be present.

In addition, unless explicitly described to the contrary, the word “comprise” and variations such as “comprises” or “comprising”, will be understood to imply the inclusion of stated elements but not the exclusion of any other elements. Further, in the specification, the word “on” means positioning on or below the object portion, but does not essentially mean positioning on the upper side of the object portion with respect to a gravitational direction.

Further, in this specification, the word “on a plane” means viewing a target portion from the top, and the word “on a cross section” means viewing a cross section vertically cutting a target portion from the side.

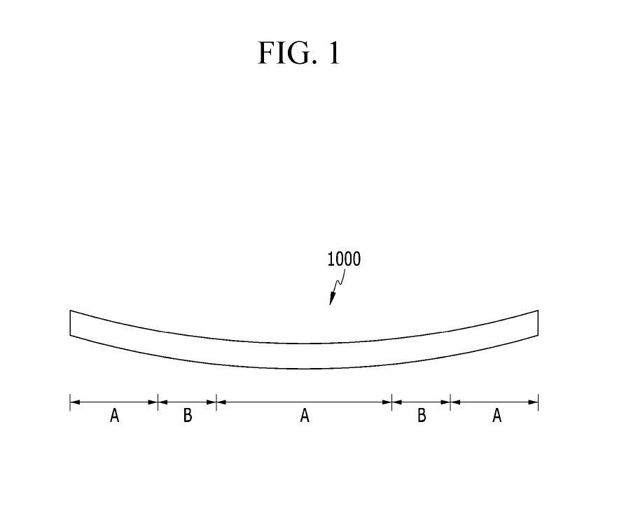

FIG. 1 is a diagram schematically illustrating a liquid crystal display 1000 according to an exemplary embodiment of the present disclosure.

Referring to FIG. 1, the liquid crystal display 1000 according to an exemplary embodiment of the present disclosure is in a bent state, that is, has a curved shape. The liquid crystal display 1000 includes a glass substrate, and has a difference in stress applied to the glass substrate according to a position on the glass substrate due to the curved shape. In the case of the liquid crystal display 1000 having the curved shape, more stress is applied to the parts of the glass substrates at or around ¼ and ¾ lengths of the glass substrate as compared with other parts on the glass substrate. In the exemplary embodiment of FIG. 1, it is described that a part that receives relatively more stress is part B, and a part that receives relatively less stress is part A.

The liquid crystal display 1000 according to an exemplary embodiment may be bent and then unfolded. In this case, the liquid crystal display 1000 may include a flexible substrate that is made of a plastic material such as polyethylene naphthalate (PEN), polycarbonate (PC), polyarylate (PAR), polyether imide (PEI), polyether sulfone (PES), and polyimide (PI).

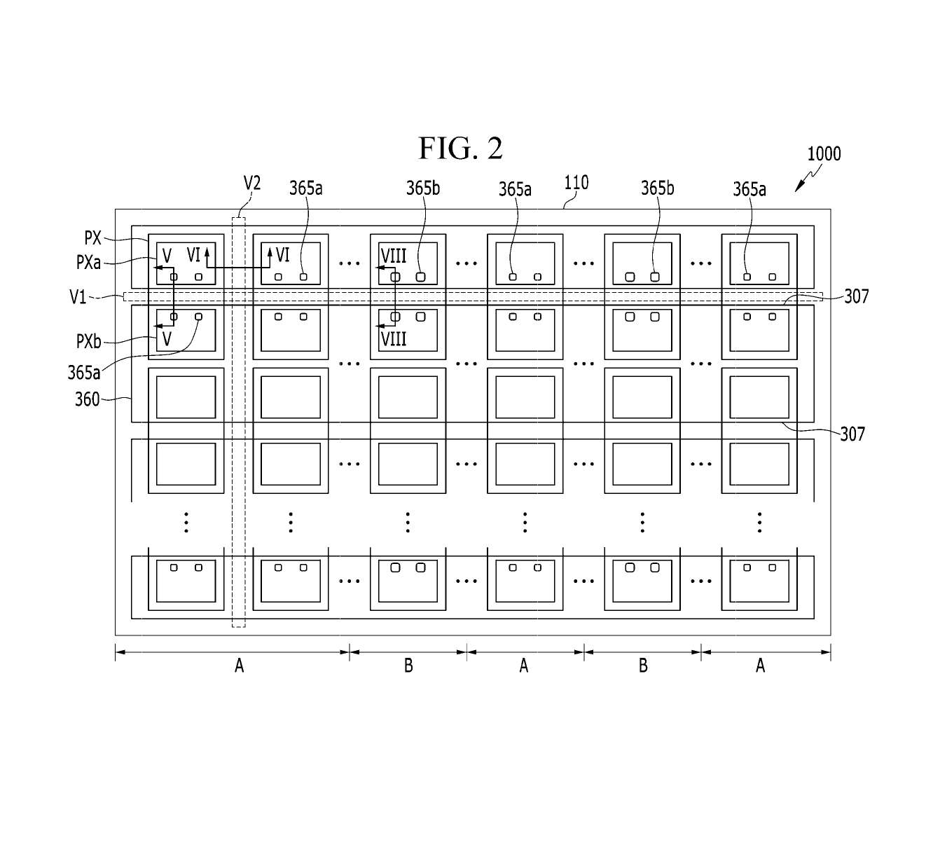

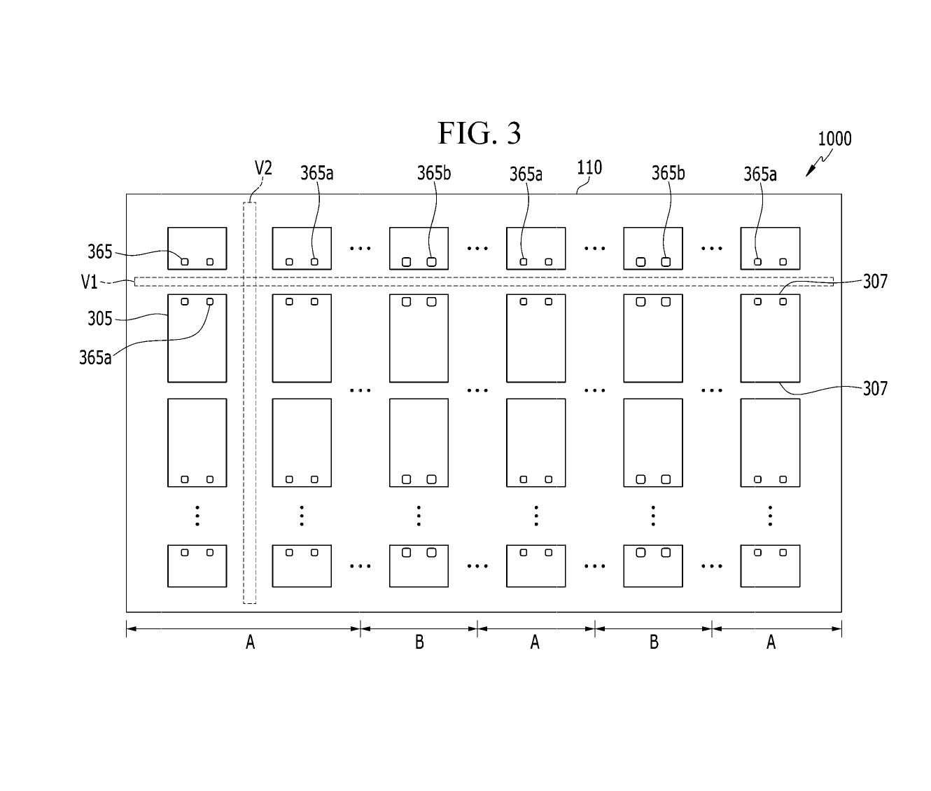

FIGS. 2 and 3 are plan views schematically illustrating the liquid crystal display according to an exemplary embodiment of the present disclosure. FIG. 2 illustrates positions of first and second support members 365a and 365b with respect to pixel areas PX, and FIG. 3 illustrates formation positions of the first and second support members 365a and 365b with respect to a microcavity.

Referring to FIGS. 2 and 3, the liquid crystal display 1000 includes a substrate 110 made of glass and a roof layer 360 formed on the substrate 110. When the liquid crystal display 1000 is bent and then unbent, the liquid crystal display 1000 may include a substrate made of transparent plastic.

The substrate 110 includes a plurality of pixel areas PX. The plurality of pixel areas PX is disposed in a matrix form that includes a plurality of pixel rows and a plurality of pixel columns. Each pixel area PX may include a first subpixel area PXa and a second subpixel area PXb. The first subpixel area PXa and the second subpixel area PXb may be vertically disposed.

A horizontal valley V1 is positioned between the first subpixel area PXa and the second subpixel area PXb in a pixel row direction, and a vertical valley V2 is positioned between the plurality of pixel columns.

The roof layer 360 may be formed along the plurality of pixel rows. In horizontal valley V1, an injection hole 307 is formed so that the microcavity 305 covered by the roof layer 360 may be exposed outside by removing the roof layer 360.

Each of the first subpixel area PXa and the second subpixel area PXb may include one injection hole 307, and the injection holes 307 of the respective subpixel areas PXa and PXb may be positioned to face each other. For example, the injection hole 307 is formed at a lower edge of the first subpixel area PXa, and the injection hole 307 is formed at an upper edge of the second subpixel area PXb.

A microcavity 305 is formed below one roof layer 360. A phenomenon in which the roof layer 360 sags may occur in the injection hole 307 corresponding to an inlet of the microcavity 305. According to an exemplary embodiment, the first and second support members 365a and 365b, which are adjacent to the injection hole 307 to support the roof layer 360, are formed. As a result, the sagging phenomenon of the roof layer 360 around the injection hole 307 may be prevented.

In the case of part B, because more stress is applied thereto than to part A, deformation of the roof layer 360 around the injection holes 307 of part B may be more significant. In an exemplary embodiment, the first support member 365a is disposed at part A, and the second support member 365a is disposed at part B. A size of a cross-sectional area of the second support member 365b is greater than a size of a cross-sectional area of the first support member 365a. Due to the structure of the second support member 365b, the roof layer 360 around the injection hole 307 at part B, which is the part receiving relatively more stress, may be prevented from being deformed by stress. Accordingly, spots of the liquid crystal display 1000 may be prevented from being generated.

The first and second support members 365a and 365b are formed at edges of two different microcavities 305 facing each other, respectively. The plurality of microcavities 305 is disposed in a matrix form that includes a plurality of pixel rows and a plurality of pixel columns. For example, the microcavity 305 may have a quadrangular shape, and a lower edge of the microcavity 305 in a first row and an upper edge of the microcavity 305 in a second row face each other. In this case, the first and second support members 365a and 365b are formed at the lower edge of the microcavity 305 in the first row and the upper edge of the microcavity 305 in the second row, which face each other, respectively.

The injection holes 307 are formed at two edges of the microcavities 305 facing each other. For example, an upper edge and a lower edge of one microcavity 305 face each other, and the injection holes 307 may be formed at an upper edge and a lower edge of the microcavity 305, respectively. In another case, the first and second support members 365a and 365b may be formed to be adjacent to one injection hole 307 of the injection holes 307 formed at two edges of each microcavity 305 facing each other, but may not be formed at the other injection hole 307. As a non-limiting example, the first and second support members 365a and 365b may be formed at a lower edge of the microcavity 305 in an odd numbered row but not formed at an upper edge. Further, the first and second support members 365a and 365b may be formed at an upper edge of the microcavity 305 in an even numbered row but not formed at a lower edge.

The horizontal valley V1 is formed between the microcavities 305 positioned in adjacent rows. When positions of the first and second support members 365a and 365b are described with respect to the horizontal valley V1, the first and second support members 365a and 365b are formed to be adjacent to both sides of the horizontal valley V1. The first and second support members 365a and 365b may be formed to be adjacent to one horizontal valley V1 of the odd numbered horizontal valley V1 and the even numbered horizontal valley V1 but not formed to be adjacent to the other horizontal valley V1 thereof. For example, the first and second support members 365a and 365b may be formed to be adjacent to both sides of a first horizontal valley V1 but not formed to be adjacent to both sides of a second horizontal valley V1.

Hereinabove, the case in which one microcavity 305 is formed throughout the first subpixel area PXa and the second subpixel area PXb of the two adjacent pixel areas PX is described, but the present disclosure is not limited thereto. For example, one microcavity 305 may be formed in one pixel area PX.

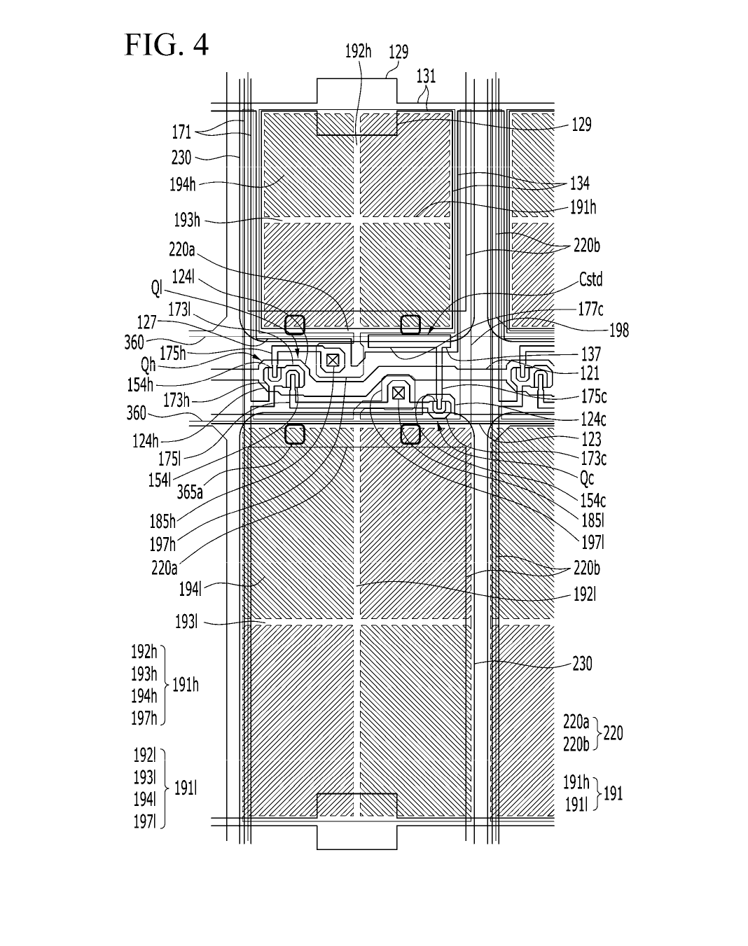

Hereinafter, the liquid crystal display according to an exemplary embodiment of the present disclosure is described in more detail with reference to FIGS. 4 to 8 in addition to FIGS. 2 and 3.

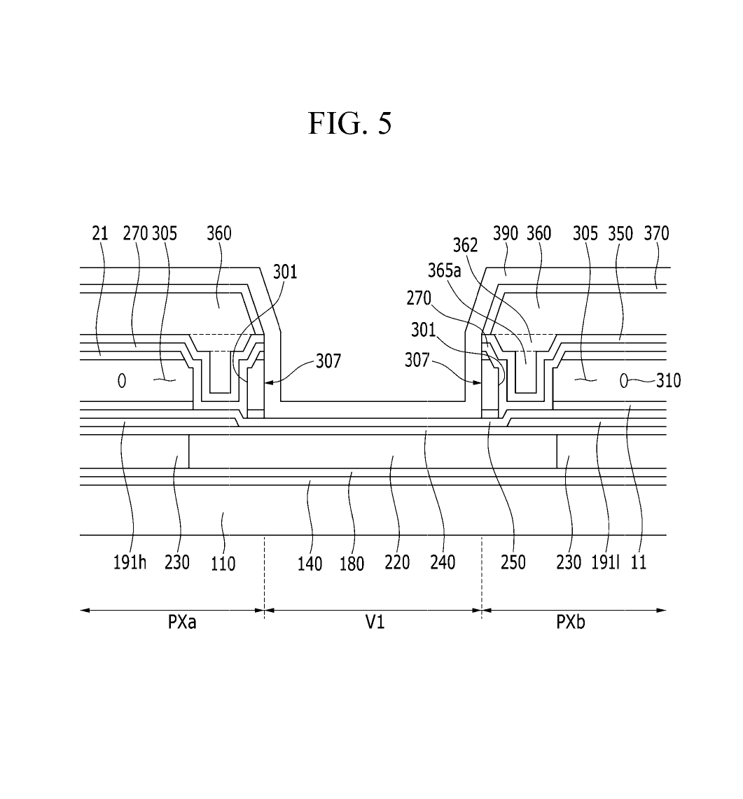

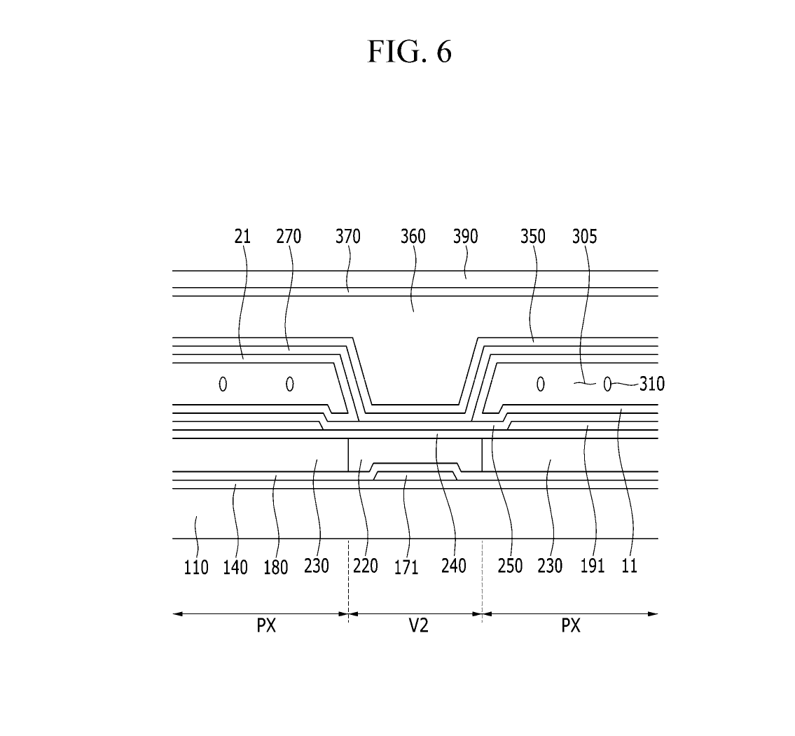

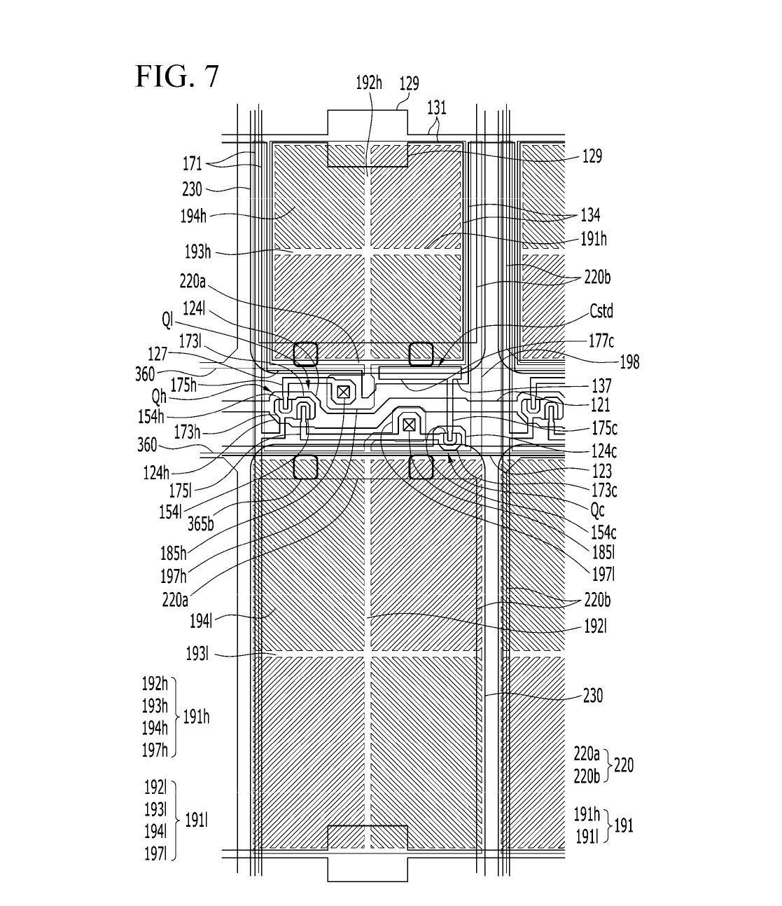

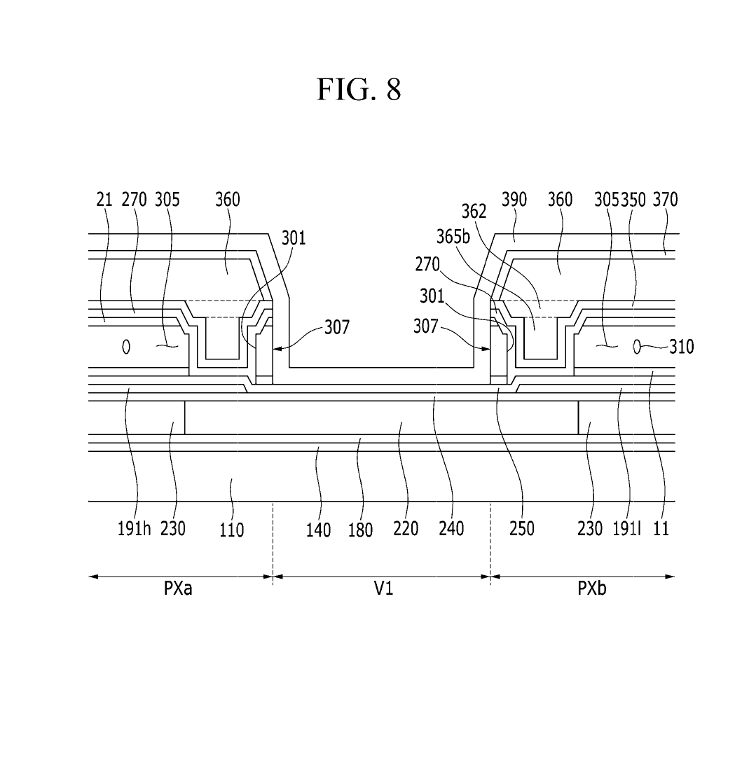

FIG. 4 is a layout view of one pixel of part A of the liquid crystal display according to an exemplary embodiment of the present disclosure. FIG. 5 is a cross-sectional view illustrating one example of a cross section taken along line V-V of FIG. 2. FIG. 6 is a cross-sectional view illustrating one example of a cross section taken along line VI-VI of FIG. 2. FIG. 7 is a layout view of one pixel of part B of the liquid crystal display according to an exemplary embodiment of the present disclosure. FIG. 8 is a cross-sectional view illustrating one example of a cross section taken along line VIII-VIII of FIG. 2.

Referring to FIGS. 2 to 6, a plurality of gate conductors including a plurality of gate lines 121, a plurality of step-down gate lines 123, and a plurality of storage electrode lines 131 is formed on the substrate 110.

The gate line 121 and the step-down gate line 123 extend mainly in a horizontal direction to transfer gate signals. The gate conductor further includes a first gate electrode 124h and a second gate electrode 124l protruding upward and downward from the gate line 121, and further includes a third gate electrode 124c protruding upward from the step-down gate line 123. The first gate electrode 124h and the second gate electrode 124l are connected with each other to form one projection. The projection form of the first to third gate electrodes 124h, 124l, and 124c may be modified.

The storage electrode line 131 extends mainly in a horizontal direction and transfers a predetermined voltage such as a common voltage Vcom. The storage electrode line 131 includes storage electrodes 129 protruding upward and downward, a pair of vertical portions 134 extending downward to be substantially vertical to the gate line 121, and a horizontal portion 127 connecting ends of the pair of vertical portions 134. The horizontal portion 127 includes a capacitor electrode 137 expanded downward.

A gate insulating layer 140 is formed on the gate conductor 121, 123, 124h, 124l, 124c, and 131. The gate insulating layer 140 may be made of an inorganic insulating material such as silicon nitride (SiNx) and silicon oxide (SiOx). Further, the gate insulating layer 140 may be formed as a single layer or a multilayer.

A first semiconductor 154h, a second semiconductor 154l, and a third semiconductor 154c are formed on the gate insulating layer 140. The first to third semiconductors 154h, 154l, and 154c may be positioned on the first to third gate electrodes 124h, 124l, and 124c, respectively. The first semiconductor 154h and the second semiconductor 154l may be connected to each other, and the second semiconductor 154l and the third semiconductor 154c may also be connected to each other. The first semiconductor 154h may extend to the lower portion of the data line 171. The first to third semiconductors 154h, 154l, and 154c may be made of amorphous silicon, polycrystalline silicon, metal oxide, and the like.

Ohmic contacts (not illustrated) may be formed on the first to third semiconductors 154h, 154l, and 154c, respectively. The ohmic contact may be made of silicide or a material such as n+ hydrogenated amorphous silicon in which an n-type impurity is doped at a high concentration.

A data conductor including a data line 171, a first source electrode 173h, a second source electrode 173l, a third source electrode 173c, a first drain electrode 175h, a second drain electrode 175l, and a third drain electrode 175c is formed on the first to third semiconductors 154h, 154l, and 154c.

The data line 171 transfers a data signal and extends mainly in a vertical direction to cross the gate lines 121 and the step-down gate lines 123. Each data line 171 includes a first source electrode 173h and a second source electrode 173l, which extend toward the first gate electrode 124h and the second gate electrode 124l and are connected to each other.

Each of the first drain electrode 175h, the second drain electrode 175l, and the third drain electrode 175c includes a wide end portion and a rod-shaped end portion. The rod-shaped end portions of the first drain electrode 175h and the second drain electrode 175l are partially surrounded by the first source electrode 173h and the second source electrode 173l. The wide end portion of the second drain electrode 175l further extends to form a third source electrode 173c, which is bent in a ‘U’-lettered shape. A wide end portion 177c of the third drain electrode 175c overlaps with the capacitive electrode 137 to form a step-down capacitor Cstd, and the rod-shaped end portion is partially surrounded by the third source electrode 173c.

The first gate electrode 124h, the first source electrode 173h, and the first drain electrode 175h form a first thin film transistor Qh together with the first semiconductor 154h. The second gate electrode 124l, the second source electrode 173l, and the second drain electrode 175l form a second thin film transistor Ql together with the second semiconductor 154l. The third gate electrode 124c, the third source electrode 173c, and the third drain electrode 175c form the third thin film transistor Qc together with the third semiconductor 154c.

The first semiconductor 154h, the second semiconductor 154l, and the third semiconductor 154c are connected to each other to have a stripe shape, and may have substantially the same planar shape as the data conductor 171, 173h, 173l, 173c, 175h, 175l, and 175c and the ohmic contacts therebelow, including the channel regions between the source electrodes 173h, 173l, and 173c and the drain electrodes 175h, 173l, and 175c.

In the first semiconductor 154h, an exposed portion that is not covered by the first source electrode 173h and the first drain electrode 175h is disposed between the first source electrode 173h and the first drain electrode 175h. In the second semiconductor 154l, an exposed portion that is not covered by the second source electrode 173l and the second drain electrode 175l is disposed between the second source electrode 173l and the second drain electrode 175l. In the third semiconductor 154c, an exposed portion that is not covered by the third source electrode 173c and the third drain electrode 175c is disposed between the third source electrode 173c and the third drain electrode 175c.

A passivation layer 180 is formed on the data conductor 171, 173h, 173l, 173c, 175h, 175l, and 175c and the semiconductors 154h, 154l, and 154c exposed between the respective source electrodes 173h, 173l, and 173c and the respective drain electrodes 175h, 175l, and 175c. The passivation layer 180 may be made of an organic insulating material or an inorganic insulating material, and may be formed as a single layer or a multilayer.

A color filter 230 in each pixel PX is formed on the passivation layer 180. Each color filter 230 may display one of the primary colors such as three primary colors of red, green and blue. The color filter 230 may also display cyan, magenta, yellow, and white-based colors, and the like. In other embodiments unlike those illustrated above, the color filter 230 may be elongated in a column direction between the adjacent data lines 171.

A light blocking member 220 is positioned in a region between the adjacent color filters 230. The light blocking member 220 is formed to overlap with a boundary of the pixel area PX, the thin film transistor, and the support member 365 to prevent light leakage. The color filter 230 is positioned in each of the first subpixel PXa and the second subpixel PXb, and the light blocking member 220 may be formed between the first subpixel PXa and the second subpixel PXb. The light blocking member 220 includes a horizontal light blocking member 220a and a vertical light blocking member 220b. The horizontal light blocking member 220a extends upward and downward along the gate line 121 and the step-down gate line 123 and covers regions in which the first thin film transistor Qh, the second thin film transistor QI, and the third thin film transistor Qc are positioned. The vertical light blocking member 220b extends along the data line 171. That is, the horizontal light blocking member 220a may be formed in the horizontal valley V1, and the vertical light blocking member 220b may be formed in the vertical valley V2. The color filter 230 and the light blocking member 220 may overlap with each other in a partial region.

A first insulating layer 240 may be further formed on the color filter 230 and the light blocking member 220. The first insulating layer 240 may be made of an inorganic insulating material such as silicon nitride (SiNx) and silicon oxide (SiOx). The first insulating layer 240 serves to protect the color filter 230 made of the organic material and the light blocking member 220, and may be omitted in some cases.

In the first insulating layer 240, the light blocking member 220, and the passivation layer 180, a first contact hole 185h and a second contact hole 185l, which expose the wide end portion of the first drain electrode 175h and the wide end portion of the second drain electrode 175l, respectively, are formed.

A pixel electrode 191 is formed on the first insulating layer 240. The pixel electrode 191 may be made of a transparent conductive material such indium tin oxide (ITO) and indium zinc oxide (IZO).

The pixel electrode 191 includes a first subpixel electrode 191h and a second subpixel electrode 191l, which are separated from each other with the gate line 121 and the step-down gate line 123 therebetween and disposed in upper and lower portions of the pixel area PX with respect to the gate line 121 and the step-down gate line 123 to be adjacent to each other in a column direction. That is, the first subpixel electrode 191h and the second subpixel electrode 191l are separated from each other with the horizontal valley V1 therebetween, the first subpixel electrode 191h is positioned in the first subpixel area PXa, and the second subpixel electrode 191l is positioned in the second subpixel area PXb.

The first subpixel electrode 191h and the second subpixel electrode 191l are connected with the first drain electrode 175h and the second drain electrode 175l through the first contact hole 185h and the second contact hole 185l, respectively. Accordingly, when the first thin film transistor Qh and the second thin film transistor Ql are turned on, the first thin film transistor Qh and the second thin film transistor Ql receive data voltages from the first drain electrode 175h and the second drain electrode 175l.

An overall shape of each of the first subpixel electrode 191h and the second subpixel electrode 191l is a quadrangle, and the first subpixel electrode 191h and the second subpixel electrode 191l include cross stems including horizontal stems 193h and 193l and vertical stems 192h and 192l crossing the horizontal stems 193h and 193l, respectively. Further, the first subpixel electrode 191h and the second subpixel electrode 191l include a plurality of minute branches 194h and 194l, and projections 197h and 197l protruding downward or upward from edge sides of the subpixel electrodes 191h and 191l, respectively.

The subpixel electrodes 191h and 191l are each divided into four domains by the horizontal stems 193h and 193l and the vertical stems 192h and 192l. The minute branches 194h and 194l obliquely extend from the horizontal stems 193h and 193l and the vertical stems 192h and 192l, and the extending direction may form an angle of approximately 45° or 135° with the gate line 121 or the horizontal stems 193h and 193l. Further, extending directions of the minute branches 194h and 194l of two adjacent domains may be orthogonal to each other.

The first subpixel electrode 191h may further include an outer stem surrounding the outside, and the second subpixel electrode 191l may further include horizontal portions positioned at an upper end and a lower end, and left and right vertical portions 198 positioned at the left and the right of the first subpixel electrode 191h. The left and right vertical portions 198 may prevent capacitive coupling between the data line 171 and the first subpixel electrode 191h.

The layout form of the pixel area, the structure of the thin film transistor, and the shape of the pixel electrode described above are just examples, and the present disclosure is not limited thereto and may be variously modified.

A second insulating layer 250 may be further formed on the pixel electrode 191. The second insulating layer 250 may be made of an inorganic insulating material such as silicon nitride (SiNx) and silicon oxide (SiOx). The second insulating layer 250 serves to protect the pixel electrode 191 and may be omitted in some cases.

The common electrode 270 is positioned on the pixel electrode 191 so as to be spaced apart from the pixel electrode 191 at a predetermined distance. A microcavity 305 is formed between the pixel electrode 191 and the common electrode 270. That is, the microcavity 305 is surrounded by the pixel electrode 191 and the common electrode 270. A width and an area of the microcavity 305 may be variously modified according to a size and a resolution of the display device.

Even though the common electrode 270 is formed to overlap with the pixel electrode 191, because the second insulating layer 250 is formed on the pixel electrode 191, the common electrode 270 and the pixel electrode 191 are prevented from contacting each other and being short-circuited.

According to an exemplary embodiment, the common electrode 270 may be formed directly on the second insulating layer 250. That is, the microcavity 305 is not formed between the pixel electrode 191 and common electrode 270, and the common electrode 270 and the pixel electrode 191 may be formed with the second insulating layer 250 therebetween. In this case, the microcavity 305 may be formed on the common electrode 270.

The common electrode 270 may be made of a transparent conductive material such as indium tin oxide (ITO) and indium zinc oxide (IZO). A predetermined voltage may be applied to the common electrode 270, and an electric field may be generated between the pixel electrode 191 and the common electrode 270.

A first alignment layer 11 is formed on the pixel electrode 191. The first alignment layer 11 may also be formed directly on the second insulating layer 250 that is not covered by the pixel electrode 191.

A second alignment layer 21 is formed below the common electrode 270 so as to face the first alignment layer 11.

The first alignment layer 11 and the second alignment layer 21 may be formed as vertical alignment layers, and made of an alignment layer formation material (simply, referred to as an “alignment material”) such as polyimide (PI), polyamic acid, and polysiloxane. The first and second alignment layers 11 and 21 may be connected to each other at the edge of the pixel area PX.

A liquid crystal layer configured by liquid crystal molecules 310 is formed in the microcavity 305 positioned between the pixel electrode 191 and the common electrode 270. The liquid crystal molecules 310 have negative dielectric anisotropy. Meaning, the liquid crystal molecules 310 may stand up in a vertical direction to the substrate 110 when no electric field is applied. That is, the liquid crystal molecules 310 may be vertically aligned.

The first subpixel electrode 191h and the second subpixel electrode 191l to which the data voltages are applied generate an electric field together with the common electrode 270 to determine the alignment directions of the liquid crystal molecules 310 positioned in the microcavity 305 between the pixel electrode 191 and the common electrode 270. Luminance of light passing through the liquid crystal layer varies according to the alignment directions of the liquid crystal molecules 310 determined above.

A third insulating layer 350 may be further formed on the common electrode 270. The third insulating layer 350 may be made of an inorganic insulating material such as silicon nitride (SiNx) and silicon oxide (SiOx), and may be omitted in some cases.

The roof layer 360 is formed on the third insulating layer 350. The roof layer 360 may be made of an organic material. The microcavity 305 is formed below the roof layer 360, and the roof layer 360 is hardened by a curing process to maintain the structure and shape of the microcavity 305. The roof layer 360 is formed to be spaced apart from the pixel electrode 191 with the microcavity 305 therebetween.

The roof layers 360 are positioned in each pixel area PX and the vertical valley V2 along a pixel row, but are not positioned in the horizontal valley V1. That is, the roof layer 360 is not formed between the first subpixel area PXa and the second subpixel area PXb. In each of the first subpixel area PXa and the second subpixel area PXb, the microcavity 305 is formed below each roof layer 360, but at the vertical valley V2, the microcavity 305 is not formed below the roof layer 360. Accordingly, a the roof layer 360 positioned in the vertical valley V2 may be formed to be thicker than the roof layer 360 positioned in the first subpixel area PXa and the second subpixel area PXb. The upper surface and both sides of the microcavity 305 are formed to be covered by the roof layer 360.

The injection hole 307 exposing a part of the microcavity 307 is formed in the roof layer 360. The injection holes 307 may be formed to face each other at the edges of the first subpixel area PXa and the second subpixel area PXb as described above. For example, the injection holes 307 may be formed to correspond to the lower edge of the first subpixel area PXa and the upper edge of the second subpixel area PXb so as to expose the sides of the microcavity 305. When a formation position of the injection hole 307 is described with respect to the microcavity 305, the injection holes 307 may be formed at two edges of each microcavity 305 facing each other. Since the microcavity 305 is exposed by the injection hole 307, an aligning agent, a liquid crystal material, or the like may be injected into the microcavity 305 through the injection holes 307.

The first support member 365a is formed adjacent to the injection hole 307 to have a column shape at the microcavity 305. The first support member 365a is formed at each of the edges of two adjacent microcavities 305 facing each other, as illustrated in FIG. 5.

Two injection holes 307 are formed at one microcavity 305. For example, respective injection holes 307 are positioned at an upper edge and a lower edge of one microcavity 305. The first support member 365a may be formed only at one of the two injection holes 307 and not formed at the other injection hole 307. For example, the first support member 365a may be formed to be adjacent to the injection hole 307 positioned at the upper edge of the microcavity 305, and the first support member 365a may not be formed at a position that is adjacent to the injection hole 307 positioned at the lower edge of the microcavity 305.

The first support member 365a may be formed to be adjacent to both sides of the odd-numbered horizontal valley V1 but not formed to be adjacent to both sides of the even-numbered horizontal valley V1. According to another exemplary embodiment, the first support member 365a may be formed to be adjacent to both sides of the even numbered horizontal valley V1 but not formed to be adjacent to both sides of the odd numbered horizontal valley V1.

The first alignment layer 11 and the second alignment layer 21 may be formed by injecting an aligning agent in which an alignment material is dissolved in a solvent. In a dry process of the aligning agent, a solid is concentrated at a place, and as a result, an alignment layer agglomeration phenomenon in which the alignment material is agglomerated occurs. At a place where the agglomeration phenomenon of the alignment layer occurs, a light leakage phenomenon, transmittance deterioration, or the like may occur, and as a result, display quality deteriorates.

In an exemplary embodiment, since the first support member 365a is formed to be adjacent to the injection hole 307 positioned at one edge of the microcavity 305, capillary forces in the two injection holes 307 formed in one microcavity 305 are different from each other. Since the capillary force in the injection hole 307 in which the first support member 365a is formed is relatively large, the agglomeration phenomenon of the alignment layer occurs at a place where the first support member 365a is formed (that is, around the injection hole 307 in which the first support member 365a is formed). Accordingly, the agglomeration phenomenon of the alignment layer may occur at the edge of the first pixel area PXa or the second pixel area PXb due to the first support member 365a according to the exemplary embodiment of the present disclosure. In the exemplary embodiment, as illustrated in FIG. 5, since the light blocking member 220 is formed to overlap with the first support member 365a, the agglomeration phenomenon of the alignment layer may be prevented from being recognized as a defect. Further, since an area of forming the light blocking member 220 may be reduced so that the first support member 365a is formed to be close to the injection hole 307, an aperture ratio may be further improved.

The sagging phenomenon of the roof layer 360 may occur at a place where the agglomeration phenomenon of the alignment layer occurs. However, in the liquid crystal display according to an exemplary embodiment of the present disclosure, since the first support member 365a is formed at the point where the agglomeration phenomenon of the alignment layer occurs to support the roof layer 360, the deformation of the roof layer 360 may be prevented.

The first support member 365a is connected with the roof layer 360, and may be made of the same material as the roof layer 360. The third insulating layer 350 and the common electrode 270 may be further positioned below the first support member 365a. The first support member 365a may overlap with the pixel electrode 191, and in this case, the common electrode 270 may also overlap with the pixel electrode 191. Since the second insulating layer 250 is formed on the pixel electrode 191, a short circuit may be prevented from being generated between the common electrode 270 and the pixel electrode 191.

In another exemplary embodiment, the first support member 365a may be made of a different material from the roof layer 360, and the third insulating layer 350 and the common electrode 270 may not be positioned below the first support member 365a. In this case, the first support member 365a may be formed directly on the pixel electrode 191, or also formed directly on the second insulating layer 250 or the first insulating layer 240. Further, by using a minute slit exposure method and the like when the light blocking member 220 or the insulating layers 240 and 250 is formed, a part of the light blocking member 220 or the insulating layers 240 and 250 protrudes to form the first support member 365a.

A planar shape of the first support member 365a is illustrated as a substantially quadrangle, but is not limited thereto, and may have various shapes such as a circle and a triangle. Further, a plurality of first support members 365a, for example, two or three first support members 365a may be formed at one edge of one microcavity 305, and the number of first support members 365a may be increased or decreased according to a size of the microcavity 305.

A step member 362 may be further formed between the first support member 365a and the roof layer 360. A width of the step member 362 may be greater than a width of the first support member 365a. The step member 362 may be made of the same material as the first support member 365a. Further, all of the step member 362, the first support member 365a, and the roof layer 360 may be made of the same material.

A fourth insulating layer 370 may be further formed on the roof layer 360. The fourth insulating layer 370 may be made of an inorganic insulating material such as silicon nitride (SiNx) and silicon oxide (SiOx). The fourth insulating layer 370 may be formed to cover an upper surface and a side of the roof layer 360. The fourth insulating layer 370 serves to protect the roof layer 360 made of an organic material and may be omitted in some cases.

A capping layer 390 may be formed on the fourth insulating layer 370. The capping layer 390 is formed to cover the injection hole 307 exposing a part of the microcavity 305 to the outside. That is, the capping layer 390 may seal the microcavity 305 so as to prevent the liquid crystal molecules 310 from being leaked after the liquid crystal is charged in the microcavity 305. Since the capping layer 390 contacts the liquid crystal molecules 310, the capping layer 390 may be made of a material, such as parylene, that does not react with liquid crystal molecules 310.

The capping layer 390 may be formed as a multilayer such as a double layer and a triple layer. The double layer is configured by two layers made of different materials. The triple layer is configured by three layers in which materials of adjacent layers are different from each other. For example, the capping layer 390 may include a layer made of an organic insulating material and a layer made of an inorganic insulating material.

Although not illustrated, polarizers may be further formed on upper and lower surfaces of the liquid crystal display. The polarizers may be configured by a first polarizer and a second polarizer. The first polarizer may be attached onto the lower surface of the substrate 110, and the second polarizer may be attached onto the capping layer 390.

Referring to FIGS. 7 and 8, the one pixel illustrated in FIG. 7 differs from the one pixel illustrated in FIG. 4 only in that FIG. 7 shows the disposition of the second support member 365b instead of the first support member 365a. Otherwise, their configurations are the same as each other. Accordingly, the description of like configurations and like elements is omitted.

When the second support member 365b and the first support member 365a are compared with each other, a size of a cross-sectional area of the second support member 365b is greater than a size of a cross-sectional area of the first support member 365a, and other configurations are the same as each other.

The second support member 365b is adjacent to the injection hole 307 to have a column shape at the microcavity 305. The second support member 365b is formed at each of the edges of two adjacent microcavities 305 facing each other, as illustrated in FIG. 8.

Two injection holes 307 are formed in one microcavity 305. For example, injection holes 307 are positioned at an upper edge and a lower edge of one microcavity 305, respectively. The second support member 365b may be formed only at one injection hole 307 of the two injection holes 307 and not formed at the other injection hole 307. For example, the second support member 365b may be formed to be adjacent to the injection hole 307 positioned at the upper edge of the microcavity 305, and the second support member 365b may not be formed at a position that is adjacent to the injection hole 307 positioned at the lower edge of the microcavity 305.

The second support member 365b may be formed to be adjacent to both sides of the odd-numbered horizontal valley V1 but not formed to be adjacent to both sides of the even-numbered horizontal valley V1. According to another exemplary embodiment, the second support member 365b may be formed to be adjacent to both sides of the even numbered horizontal valley V1 but not formed to be adjacent to both sides of the odd numbered horizontal valley V1.

The second support member 365b is disposed to overlap with the light blocking member 220, and as a result, the agglomeration phenomenon of the alignment layer may be prevented from being recognized as a defect. Further, since an area of forming the light blocking member 220 may be reduced as the second support member 365b is formed to be closer to the injection hole 307, an aperture ratio may be further improved.

The sagging phenomenon of the roof layer 360 may occur at the portion where the aggregation of the alignment layer occurs, that is, around the injection hole 307 in which the second support member 365b is formed. However, in the liquid crystal display according to an exemplary embodiment of the present disclosure, since the second support member 365b is formed at the point where the agglomeration phenomenon of the alignment layer occurs to support the roof layer 360, the deformation of the roof layer 360 may be prevented.

According to an exemplary embodiment, the second support member 365b is disposed in part B, which receives relatively more stress, and the first support member 365a is disposed is in part A, which receives relatively less stress.

Thus, although the roof layer 360 around the injection hole 307 in part B may be subject to more deformation-causing stress, because the second support member 365b having a size of the cross-sectional area greater than that of the first support member 365a is disposed according to an exemplary embodiment, the roof layer 360 around the injection hole 307 may be prevented from being deformed due to the stress.

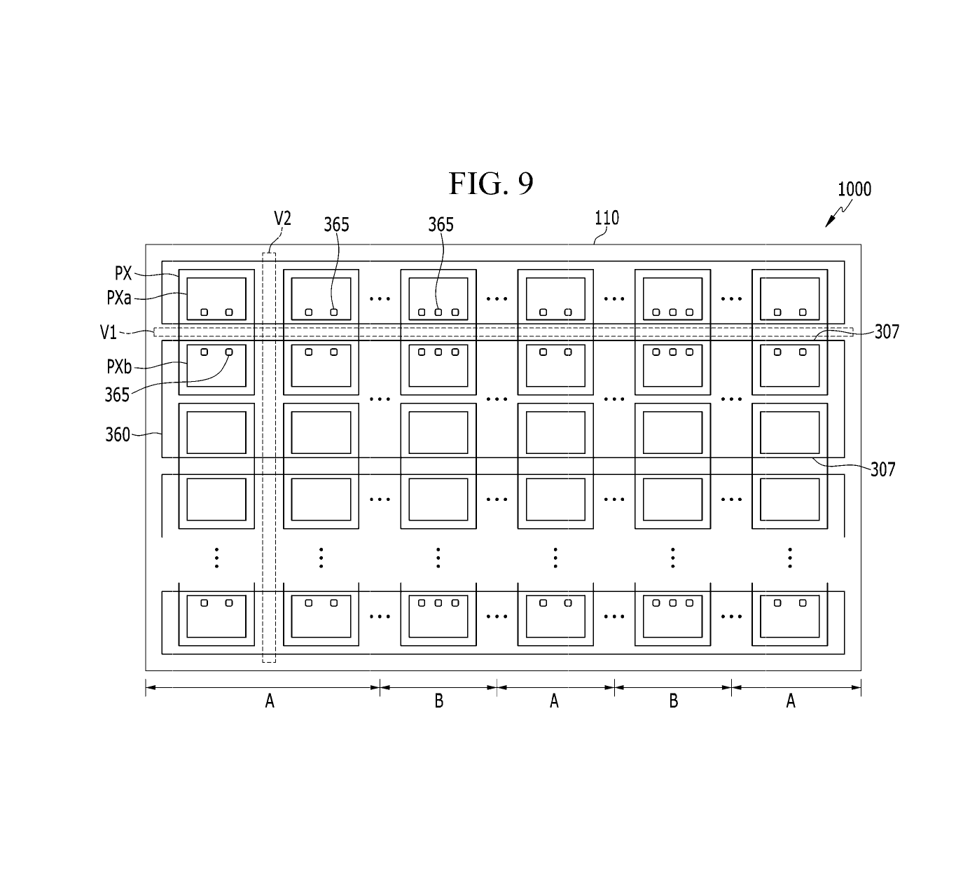

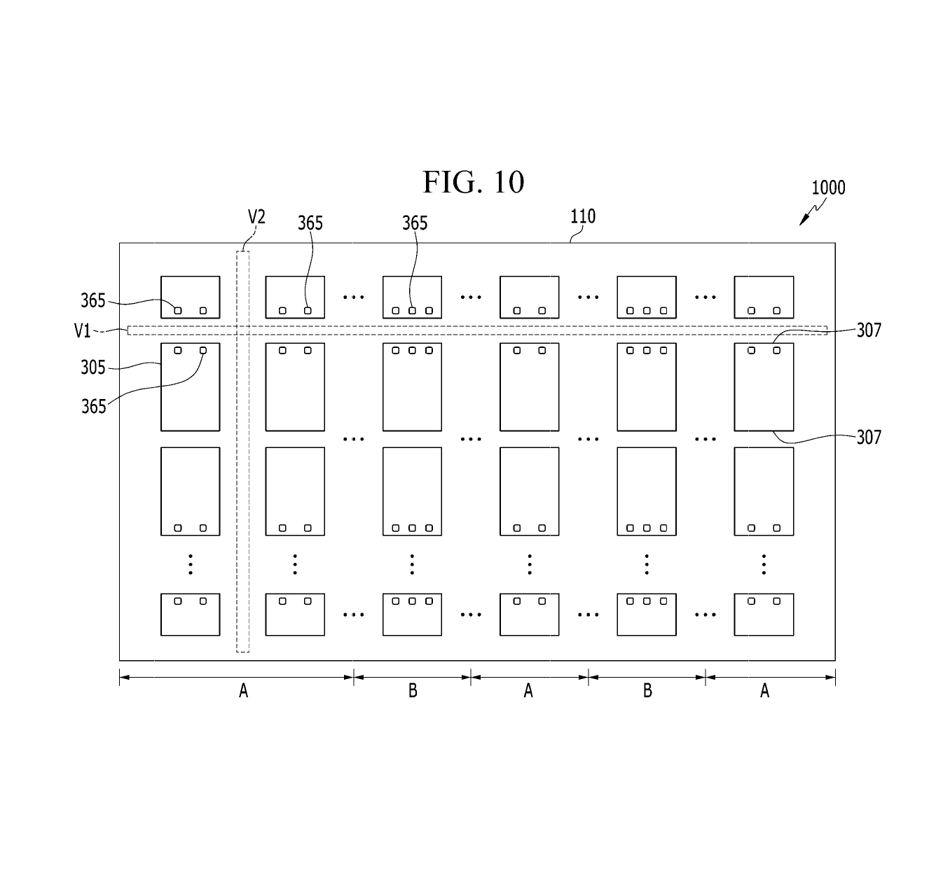

Next, a liquid crystal display according to another exemplary embodiment of the present disclosure is described in detail with reference to FIGS. 9 and 10.

FIGS. 9 and 10 are layout views schematically illustrating a liquid crystal display according to another exemplary embodiment of the present disclosure. FIG. 9 illustrates a position of the support member 365 with respect to the pixel areas PX, and FIG. 10 illustrates a formation position of the support member 365 with respect to the microcavity.

Referring to FIGS. 9 and 10, when the liquid crystal display 1000 of FIGS. 9 and 10 is compared with the liquid crystal display of FIGS. 2 and 3, the number of support members 365 disposed at part B is different from each other, but other structures are the same as each other. Accordingly, the description of like structures is omitted.

The support member 365, which is adjacent to the injection hole 307 to support the roof layer 360, is disposed to prevent the sagging phenomenon of the roof layer 360 around the injection hole 307. The support member 365 is disposed to overlap with the light blocking member 220, and as a result, the agglomeration phenomenon of the alignment layer may be prevented from being recognized as a defect. Since an area of forming the light blocking member 220 may be reduced as the support member 365 is formed to be closer to the injection hole 307, an aperture ratio may be further improved.

The support member 365 is disposed at one edge of one microcavity 305, and the number of support members 365 disposed at part B, which receives relatively more stress, is greater than the number of support members 365 disposed at part A, which receives relatively less stress. At part A, two support members 365 are disposed at one edge of one microcavity 305, and at part B, three support members 365 are disposed at one edge of one microcavity 305. That is, a greater number of support members 365 is disposed in part B, which receives relatively more stress, compared to part A, which receives relatively less stress. As such, the roof layer 360 around the injection hole 307 is prevented from being deformed due to the stress.

Here, the size of the cross-sectional area of the support member 365 disposed at part B may be equal to or greater than that of the support member 365 disposed at part A.

In the exemplary embodiments of FIGS. 9 and 10, two support members 365 are disposed at one edge of one microcavity 305 at part A, and three support members 365 are disposed at one edge of one edge of one microcavity 305 at part B, but the present disclosure is not limited thereto, and the number of support members 365 may be increased.

While the present system and method have been described in connection with exemplary embodiments, it is to be understood that the present system and method are not limited to the disclosed embodiments. On the contrary, the present system and method are intended to cover various modifications and equivalent arrangements included within the spirit and scope of the appended claims.

<Description of symbols>

| | |
|---|---|
| 11, 21: Alignment layer | 110: Substrate |
| 121: Gate line | 123: Step-down gate line |
| 124h, 124l, 124c: First, second, third | |
| gate electrodes | |
| 154h, 154l, 154c: First, second, third | |
| semiconductors | |
| 171: Data line | |
| 173h, 173l, 173c: First, second, third | |
| source electrodes | |
| 175h, 175l, 175c: First, second, third | |
| drain electrodes | |
| 191: Pixel electrode | 220: Light blocking member |
| 230: Color filter | 270: Common electrode |
| 300: Sacrificial layer | 305: Microcavity |
| 307: Injection hole | 310: Liquid crystal molecule |
| 360: Roof layer | 362: Step member |
| 365: Support member | |
| 365a, 365b: First and second support | |
| members | |
| 390: Capping layer | |

What is claimed is:

1. A liquid crystal display, comprising:
a substrate including a first portion, a second portion receiving more stress than the first portion, and a plurality of pixel areas disposed in a matrix form spanning the first and second portions;
a plurality of thin film transistors formed on the substrate;
a plurality of pixel electrodes, each connected to a thin film transistor and disposed in a pixel area;
a roof layer disposed on the pixel electrodes to be spaced apart from the pixel electrodes such that a plurality of microcavities is formed between the pixel electrodes and the roof layer;
injection holes positioned at two edges of each of the microcavities;
a first support member disposed adjacent to an injection hole positioned at one edge of a microcavity in the first portion and supporting the roof layer;
a second support member disposed adjacent to an injection hole positioned at one edge of a microcavity in the second portion and supporting the roof layer;
an alignment layer positioned on an inner surface of each of the microcavities; and
a liquid crystal layer positioned in each of the microcavities,
wherein a size of a cross-sectional area of the second support member is greater than a size of a cross-sectional area of the first support member.

2. The liquid crystal display of claim 1, wherein the second portion is positioned at ¼ of a length and ¾ of a length of the substrate.

3. The liquid crystal display of claim 2, wherein first support members are disposed at two edges of the microcavity in the first portion, the two edges thereof are adjacent to each other in a column direction and face each other, and
second support members are disposed at two edges of the microcavity in the second portion, the two edges thereof are adjacent to each other in the column direction and face each other.

4. The liquid crystal display of claim 3, wherein the microcavities are disposed in a matrix form, and a first valley is formed between the microcavities positioned in different rows.

5. The liquid crystal display of claim 4, wherein the first support member and the second support member are disposed to be adjacent to two sides of the first valley.

6. The liquid crystal display of claim 5, wherein each of the first support member and the second support member is positioned to be adjacent to only one first valley from a group consisting of an odd numbered first valley and an even numbered first valley.

7. The liquid crystal display of claim 1, further comprising step members formed between the first support member and the second support member and the roof layer, wherein the step members have a width greater than that of each of the first support member and the second support member.

8. The liquid crystal display of claim 7, wherein the first support member, the second support member, the roof layer, and the step member are made of the same material.

9. The liquid crystal display of claim 1, wherein a plurality of first support members is disposed at one edge of the microcavity in the first portion, and a plurality of second support members is disposed at one edge of the microcavity in the second portion.

10. The liquid crystal display of claim 9, wherein the number of second support members disposed at one edge of the microcavity in the first portion is greater than the number of first support members disposed at one edge of the microcavity in the second portion.

11. The liquid crystal display of claim 1, further comprising a capping layer covering the injection holes and disposed on the roof layer.

12. The liquid crystal display of claim 1, further comprising a common electrode disposed on an upper inner surface of each of the microcavities,
wherein the common electrode is disposed between the alignment layer and the roof layer.

13. The liquid crystal display of claim 1, further comprising an insulating layer disposed between each of the first support member and the second support member and a corresponding pixel electrode,
wherein each of the first support member and the second support member overlap with the corresponding pixel electrode.
